(19) United States
(12) Patent Application Publication
(10) Pub. No.: US 2009/0309904 A1
(43) Pub. Date: Dec. 17, 2009

(54) RECORDING APPARATUS AND ELECTRONIC APPARATUS

(75) Inventors: Yoshiaki SHIBASAKI, Azumino-shi (JP); Kazuhisa NAKAMURA, Matsumoto-shi (JP); Kosaku NOBUTA, Suwa-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/477,233

(22) Filed: Jun. 3, 2009

(30) Foreign Application Priority Data
Jun. 16, 2008 (JP) 2008-156296

(51) Int. Cl. B41J 2/01

(52) U.S. Cl. 347/1

(57) ABSTRACT

A recording apparatus that performs recording on a recording medium includes a control unit. The control unit supplies power to a movement detecting unit, which is configured to detect movement of at least one drive section to be controlled, and monitors an amount of movement of the at least one drive section during a power-saving mode.

### BACKGROUND

1. Technical Field

The present invention relates to recording apparatuses typified by facsimile apparatuses and printers, and to electronic apparatuses.

2. Related Art

Recording apparatuses typified by facsimile apparatuses and printers are generally made to switch to a power-saving mode if no operation is performed for a certain period of time while the power is turned on or if there is no input of information from the outside for a certain period of time. Examples of such technology related to a power-saving mode are disclosed in JP-A-2005-238557, JP-A-2005-250326, JP-A-2007-168295, JP-A-2006-201868, and JP-A-2004-357023.

Specifically, JP-A-2005-238557 discloses a serial printer configured to discontinue the supply of power to a carriage-position detecting sensor when switching to a power-saving mode and to seek the home position of the carriage after cancelling the power-saving mode.

JP-A-2005-250326 discloses an image forming apparatus configured to supply power to a fixing heater and to a door open/close sensor, which detects whether various doors in the apparatus are open or closed, during a power-saving mode in order to shorten the recovery period from the power-saving mode. When the door open/close sensor detects that a door is open, the image forming apparatus discontinues the supply of power to the fixing heater in order to ensure safety.

JP-A-2004-357023 discloses an image reading apparatus configured to supply power to a cover open/close sensor, which detects an open/closed state of a document-table cover included in an image scanner, during a power-saving mode. When the open or closed state of the document-table cover is detected, the image reading apparatus cancels the power-saving mode.

However, seeking the home position of the carriage in the serial printer of the aforementioned type is time-consuming. For this reason, when the serial printer receives a recording execution command during the power-saving mode, a certain amount of time is required before the printer can commence the actual recording. This undesirably results in a long waiting time for the user. None of JP-A-2005-238557, JP-A-2005-250326, JP-A-2007-168295, JP-A-2006-201868, and JP-A-2004-357023 discuss a solution for solving such a technical problem.

### SUMMARY

An advantage of some aspects of the invention is that an electronic apparatus and a recording apparatus are provided, which can immediately perform their operation even when an operation execution command is received during a power-saving mode.

A recording apparatus according to a first aspect of the invention is configured to perform recording on a recording medium and includes a control unit. The control unit supplies power to a movement detecting unit, which is configured to detect movement of at least one drive section to be controlled, and monitors an amount of movement of the at least one drive section during a power-saving mode.

According to the first aspect, since the control unit of the recording apparatus supplies power to the movement detecting unit, which is configured to detect movement of the drive section, and monitors an amount of movement of the drive section during the power-saving mode, the control unit can ascertain the present state (such as the position or the orientation) of the drive section without having to perform a resetting operation or a home-position seeking operation for ascertaining the position of the drive section after cancelling the power-saving mode. Thus, when a recording execution command is received during the power-saving mode, recording can be commenced immediately.

In the first aspect of the invention, the control unit preferably cancels the power-saving mode when the movement detecting unit detects movement of the at least one drive section during the power-saving mode.

Accordingly, since the control unit may be configured to cancel the power-saving mode when the movement detecting unit detects movement of the drive section during the power-saving mode, the drive section is prevented from being kept in an unfavorable state for a long time, such as a state where the drive section is kept moving by an external force for a long time, thereby preventing an adverse effect on the apparatus.

Furthermore, the control unit preferably performs maintenance on a recording head, which is configured to perform recording on the recording medium, after cancelling the power-saving mode.

If the drive section is moved by an external force during the power-saving mode, there is a possibility that the apparatus may have received an impact force. In that case, if the recording head is an inkjet recording head, air bubbles may possibly form within the nozzles and ultimately result in missing dots. However, since the control unit may perform maintenance on the recording head (such as removing ink from the inkjet nozzles by suction) after cancelling the power-saving mode, the occurrence of such a problem can be prevented.

In the first aspect of the invention, it is preferable that the recording apparatus further include a transport roller that acts as the at least one drive section and is configured to transport the recording medium; a rotation detecting unit that acts as the movement detecting unit and is configured to detect rotation of the transport roller; a tray that is provided in a shiftable manner between a setting position, a recording position, and a storage position, the tray being shifted to the setting position by being ejected from an interior to an exterior of the apparatus so that a thin-plate body is settable on the tray, the recording position being where recording is performed on the thin-plate body, the storage position being where the tray is stored inside the apparatus; and a tray driving unit that is configured to shift the tray by receiving power from a motor via the transport roller. In this case, the control unit preferably cancels the power-saving mode when the rotation detecting unit detects rotation of the transport roller during the power-saving mode.

When the rotation detecting unit detects rotation of the transport roller during the power-saving mode, it can be determined that the tray is moved from its exterior position by some kind of operation performed by the user. In that case, the power-saving mode is cancelled so that recording to be performed using the tray can be commenced immediately.

An electronic apparatus according to a second aspect of the invention includes at least one drive section; a movement detecting unit that is configured to detect movement of the at least one drive section; and a control unit that controls the movement of the at least one drive section on the basis of information sent from the movement detecting unit and controls supply of power to the at least one drive section and the movement detecting unit. The control unit supplies power to the movement detecting unit and monitors an amount of movement of the at least one drive section during a power-saving mode.

According to the second aspect, since the control unit of the electronic apparatus supplies power to the movement detecting unit, which is configured to detect movement of the drive section, and monitors an amount of movement of the drive section during the power-saving mode, the control unit can ascertain the present state (such as the position or the orientation) of the drive section without having to perform a resetting operation or a home-position seeking operation for ascertaining the position of the drive section after cancelling the power-saving mode. Thus, when an operation execution command is received during the power-saving mode, the operation can be commenced immediately.

### BRIEF DESCRIPTION OF THE DRAWINGS

The invention will be described with reference to the accompanying drawings, wherein like numbers reference like elements.

FIG. 1 is a cross-sectional view showing a sheet transporting path in a printer according to an embodiment of the invention.

FIG. 2 is a block diagram of a control system having a control device as a central unit in the printer according to the embodiment of the invention.

FIG. 3 schematically illustrates a movable range of a carriage.

FIG. 4 is a flow chart illustrating a process for switching to a power-saving mode.

FIG. 5 is a flow chart illustrating a process for cancelling the power-saving mode.

### DESCRIPTION OF EXEMPLARY EMBODIMENTS

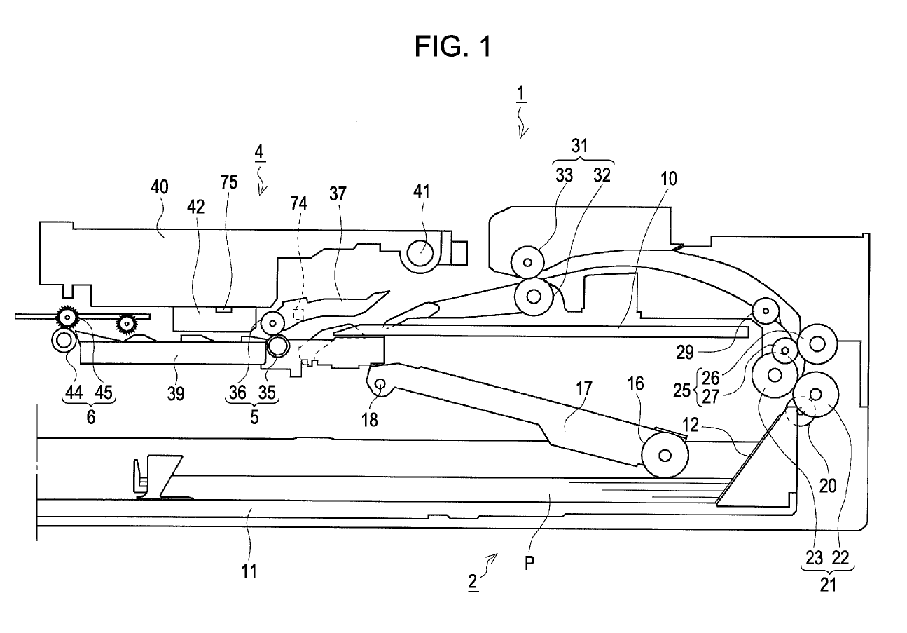

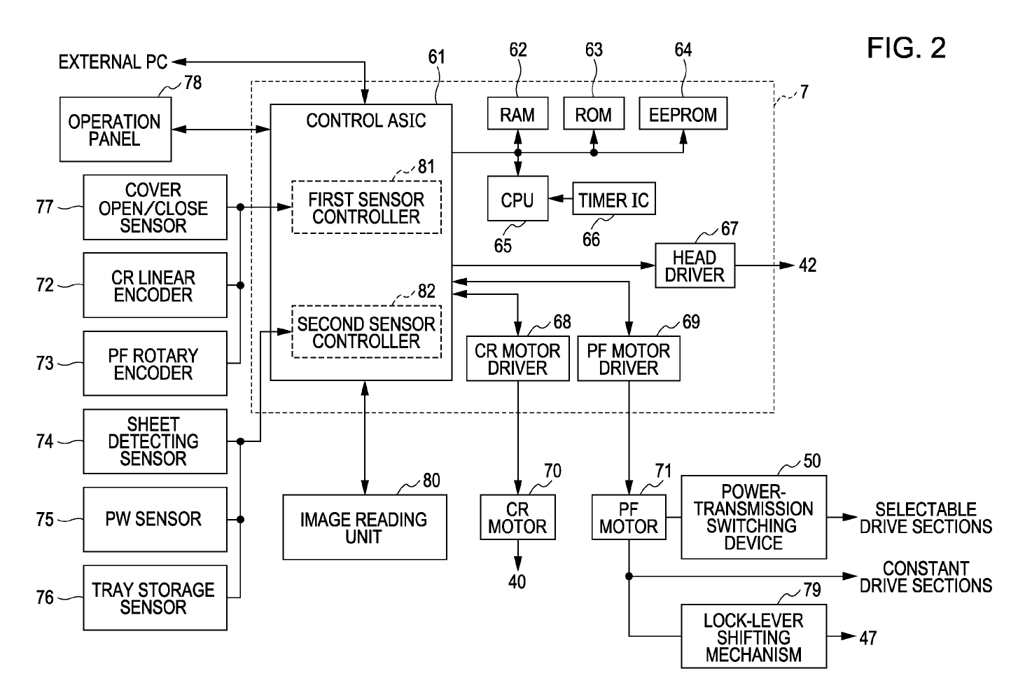

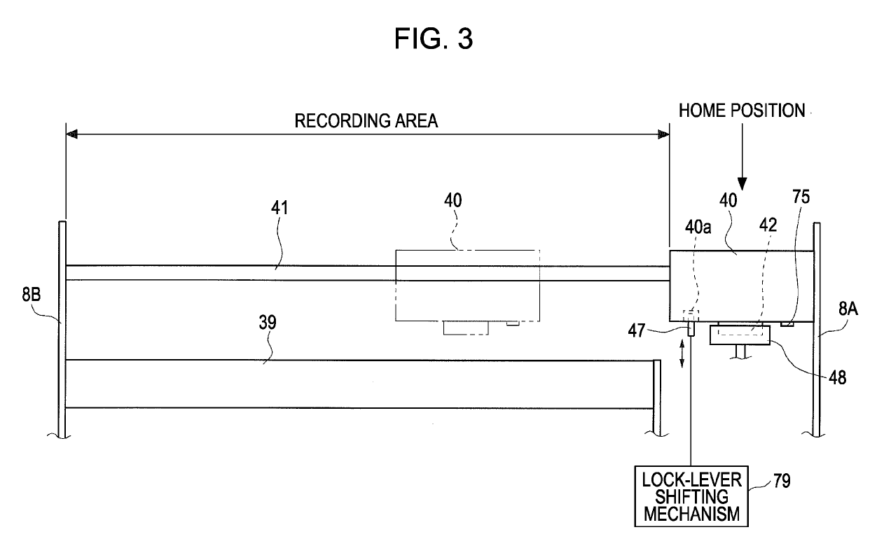

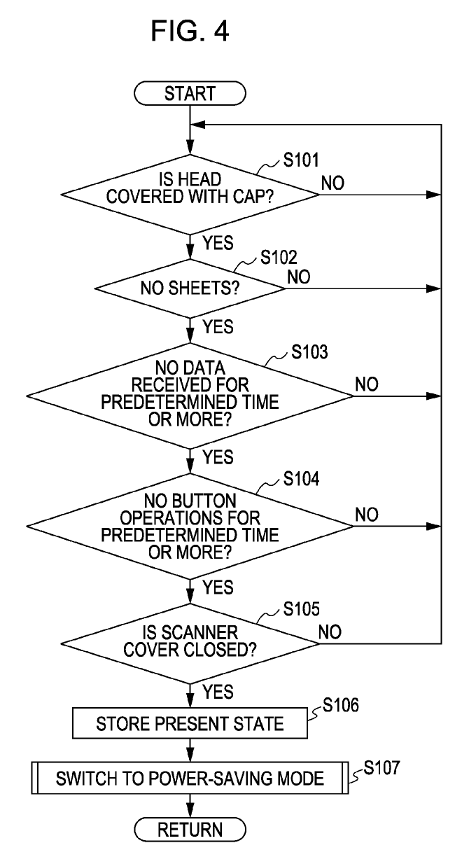

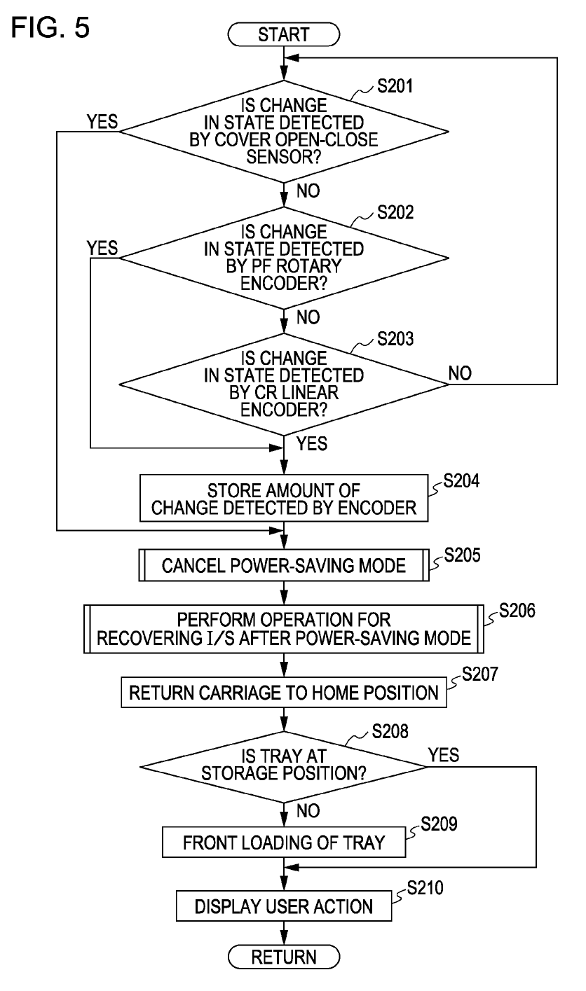

An embodiment of the invention will now be described with reference to FIGS. 1 to 5. FIG. 1 is a cross-sectional view showing a sheet transporting path in an inkjet printer (referred to as a “printer” hereinafter) 1 as one of examples of a recording apparatus, which is an example of an electronic apparatus according to an embodiment of the invention. FIG. 2 is a block diagram of a control system having a control device 7 as a central unit. FIG. 3 schematically illustrates a movable range of a carriage 40. FIG. 4 is a flow chart illustrating a process for switching to a power-saving mode. FIG. 5 is a flow chart illustrating a process for cancelling the power-saving mode.

A configuration of the printer 1 will be described below with reference to FIGS. 1 to 3. The printer 1 includes a feeder device 2 at the bottom of the printer 1. The printer 1 is a serial printer that feeds recording sheets P one by one from the feeder device 2, performs inkjet recording on each sheet P at a recording unit 4, and ejects the sheet P towards a stacker tray (not shown) provided at the front of the printer 1 (i.e., the left side in FIG. 1).

The printer 1 also includes an image reading unit (scanner unit) 80 (not shown in FIG. 1 but shown in FIG. 2) at the top thereof. The printer 1 is of a stand-alone type that can perform inkjet recording using an original image read as recording data by this image reading unit 80.

The components constituting the printer 1 will be described in detail below. The feeder device 2 includes a paper cassette 11, a pick-up roller 16, a guide roller 20, and a separating unit 21. The pick-up roller 16, which is rotationally driven by a paper-feed (PF) motor 71 (see FIG. 2), is provided at a pivotable member 17 that pivots about a pivot shaft 18 and is configured to rotate in contact with an uppermost sheet P accommodated in the paper cassette 11 so as to feed the sheet P from the paper cassette 11.

The sheet P fed from the paper cassette 11 undergoes a first separation process performed by a separating member 12, then travels downstream while being guided by the guide roller 20, and finally undergoes a second separation process performed by the separating unit 21, which is constituted by a separating roller 22 and a driving roller 23.

A first intermediate transport unit 25 is disposed downstream of the separating unit 21. Specifically, the first intermediate transport unit 25 includes a driving roller 26 rotationally driven by the PF motor 71 (see FIG. 2) and an assist roller 27 rotationally driven by the driving roller 26 when the assist roller 27 and the driving roller 26 nip the sheet P therebetween. The first intermediate transport unit 25 transports the sheet P further downstream. Reference numeral 29 denotes a driven roller that reduces load applied to the sheet P when the sheet P (especially the trailing end thereof) passes through a curved reversing path.

A second intermediate transport unit 31 is provided downstream of the driven roller 29. Specifically, the second intermediate transport unit 31 includes a driving roller 32 rotationally driven by the PF motor 71 (see FIG. 2) and an assist roller 33 rotationally driven by the driving roller 32 when the assist roller 33 and the driving roller 32 nip the sheet P therebetween. The second intermediate transport unit 31 transports the sheet P further downstream.

The recording unit 4 is disposed downstream of the second intermediate transport unit 31. The recording unit 4 includes a transport unit 5, a recording head 42, a frontal sheet guide 39, and an ejecting unit 6. The transport unit 5 includes a transport-driving roller 35 acting as a transport roller rotationally driven by the PF motor 71 (see FIG. 2) and a transport-driven roller 36 rotatably supported by an upper sheet guide 37 and rotationally driven by the transport-driving roller 35 by being in pressure contact therewith. The transport unit 5 accurately transports the sheet P towards a position facing the recording head 42.

Reference numeral 74 denotes a sheet detecting sensor (such as an optical sensor) acting as a medium detecting unit that detects the passing of the sheet P. The control device 7 to be described later is capable of detecting the passing of the leading end or the trailing end of the sheet P by using this sheet detecting sensor 74.

The recording head 42 is provided at the bottom of the carriage 40. The carriage 40 is driven back and forth by a carriage (CR) motor 70 (see FIG. 2) in a scanning direction of the recording head 42 (i.e., in a direction orthogonal to the plane of the drawing in FIG. 1) while being guided by a carriage guide shaft 41 extending in the scanning direction. The frontal sheet guide 39 is provided at a position facing the recording head 42. The frontal sheet guide 39 is configured to determine the distance between one sheet P and a subsequent sheet P.

The carriage guide shaft 41 is movable in the vertical direction by an automatic gap-adjusting mechanism (not shown and referred to as an “APG mechanism” hereinafter). The APG mechanism can adjust the distance (i.e., a gap which will sometimes be referred to as a “PG” hereinafter, where appropriate) between a head face of the recording head 42 and the frontal sheet guide 39, depending on the thickness of a medium subjected to recording.

Reference numeral 75 denotes a PW sensor. The PW sensor 75 is an optical sensor provided at the bottom of the carriage 40 and includes a light emitter (not shown) that emits light toward the frontal sheet guide 39 and a light receiver (not shown) that receives the light reflected by the frontal sheet guide 39. The PW sensor 75 is configured to emit the light toward the frontal sheet guide 39, receive the reflected light, convert the reflected light into an electric current, and send the electric current to the control device 7 to be described later. Thus, based on a detection value (i.e., an electric current value) obtained depending on an object to be detected (such as the frontal sheet guide 39 or the recording sheet P), the control device 7 can detect the presence or absence of a sheet P or the width of a sheet P sensed by the PW sensor 75 with the movement of the carriage 40.

As shown in FIG. 3, the carriage guide shaft 41 is supported by side frames 8A and 8B that constitute the base body of the printer 1. A home position of the carriage 40 is set near the side frame 8A. At this home position, a lock lever 47 is provided, which acts as a locking unit that locks the carriage 40 to prevent it from moving from the home position.

The lock lever 47 can be shifted towards or away from the carriage 40 by a lock-lever shifting mechanism 79. When shifted towards the carriage 40, an end of the lock lever 47 fits into a hole 40a formed in the carriage 40, thereby locking the carriage 40 to the home position.

Reference numeral 48 denotes a capping device that seals a nozzle face of the recording head 42. This capping device 48 has a lifting/lowering mechanism (not shown) and is lowered when the carriage 40 is positioned within a recording area. When the carriage 40 moves to the home position, the capping device 48 engages with the carriage 40 and receives pressure therefrom, thereby ascending to a position where the capping device 48 seals the nozzle face of the recording head 42.

The capping device 48 is in communication with a pumping device (not shown). This pumping device generates negative pressure inside the capping device so as to perform maintenance on the recording head 42, such as removing ink from inkjet nozzles of the recording head 42 by suction.

Referring to FIG. 1, the ejecting unit 6 provided downstream of the frontal sheet guide 39 includes an ejecting-driving roller 44 rotationally driven by the PF motor 71 (see FIG. 2) and an ejecting-driven roller 45 rotationally driven by the ejecting-driving roller 44 by being in contact therewith. The ejecting unit 6 ejects a sheet P having undergone recording at the recording unit 4 onto the stacker tray (not shown) provided at the front of the printer 1.

The printer 1 has a detachable duplex unit (not shown) at the rear of thereof. With this duplex unit, the printer 1 can perform recording on both sides of a sheet P by first performing recording on a first face of the sheet P and then reversing the sheet P along a curved path so that a second face, i.e., reverse face, of the sheet P faces the recording head 42.

The printer 1 contains a disc tray 10 on which an optical disc (not shown), which is an example of a thin-plate body, can be set. By setting an optical disc on this disc tray 10, the printer 1 can directly perform inkjet recording on the label face of the optical disc.

A tray drive section (not shown) that receives power from the transport-driving roller 35 via a power-transmission switching device 50 to be described later can shift the disc tray 10 between a storage position shown in FIG. 1 and a setting position. When the disc tray 10 is at this setting position, the disc tray 10 is ejected to the downstream side of the ejecting unit 6 (that is, to the exterior of the printer 1) so that an optical disc can be set thereon. A recording position at which the recording head 42 performs recording is located between the storage position and the setting position.

A tray storage sensor 76 (see FIG. 2) is provided at the storage position of the disc tray 10. This tray storage sensor 76 can detect whether or not the disc tray 10 is present at the storage position.

In addition to the above description of the configuration of the printer 1, the control device 7 and peripheral components thereof will be described below with reference to FIG. 2.

The printer 1 is equipped with two motors as power sources, one of which being the PF motor 71 and the other being the CR motor 70. These two motors are controlled by the control device 7.

The PF motor 71 is a common driving source for the rollers provided in the sheet transporting path, such as the transport-driving roller 35 (of the transport unit 5), the ejecting-driving roller 44 (of the ejecting unit 6), and the driving roller 32 (of the second intermediate transport unit 31), and selectively drives various power-requiring drive sections in the printer 1 via the power-transmission switching device 50.

In FIG. 2, “selectable drive sections” correspond to these various drive sections and include the feeder device 2, the pumping device (not shown), the APG mechanism, the duplex unit, and the tray drive section. The power-transmission switching device 50 uses the transport-driving roller 35 as a power shaft and selects a drive section to which power is to be transmitted by switching the rotational direction of the transport-driving roller 35 and by being triggered by the carriage 40.

On the other hand, the CR motor 70 is a driving source for the carriage 40. Rotation of the CR motor 70 causes the carriage 40 (the recording head 42) to move in a main scanning direction (i.e., the horizontal direction in FIG. 3). A position of the carriage 40 in the main scanning direction can be detected by a CR linear encoder 72, whereby the control device 7 can detect the position, the traveling direction, and the traveling speed of the carriage 40.

As mentioned above, the PF motor 71 is a common driving source for the individual rollers provided in the sheet transporting path, and the amount of rotation (i.e., the number of rotation steps) and the rotational speed of the PF motor 71 can be detected by a PF rotary encoder 73. In consequence, the control device 7 can detect the amount of rotation and the rotational speed of each roller provided in the sheet transporting path.

In FIG. 2, “constant drive sections” correspond to rollers such as the driving roller 32, the transport-driving roller 35, and the ejecting-driving roller 44 shown in FIG. 1. These rollers constantly rotate in response to the rotation of the PF motor 71. The lock-lever shifting mechanism 79 utilizes switching of the rotational direction of the PF motor 71 so as to shift the lock lever 47 towards or away from the carriage 40.

The control device 7 will now be described. The control device 7 has a system bus that is connected to a control application-specific-integrated-circuit (ASIC) 61, a random-access memory (RAM) 62, a read-only memory (ROM) 63, an electrically erasable programmable read-only memory (EEPROM) 64, a central processing unit (CPU) 65, and a timer integrated-circuit (IC) 66. The CPU 65 receives signals from encoders and sensors, such as the CR linear encoder 72, the PF rotary encoder 73, the sheet detecting sensor 74, the PW sensor 75, the tray storage sensor 76, and a cover open/close sensor 77, via the control ASIC 61.

The CPU 65 also receives signals from an operation panel 78 having, for example, operating portions, such as a power button for turning the printer 1 on and off and various setting and execution buttons, and a display portion that displays various information. Furthermore, the CPU 65 receives read image data from the image reading unit 80 and outputs control information to the image reading unit 80.

Based on the output signals from the various sensors and encoders in the printer 1, the CPU 65 performs a calculation process for executing various control of the printer 1 (including the image reading unit 80) as well as other necessary calculation processes. The ROM 63 stores, for example, a recording control program (firmware) required by the CPU 65 for controlling the printer 1. The EEPROM 64 stores various data necessary for the recording control program. The RAM 62 is used as a work area of the CPU 65 and as a temporary storage area for storing recording data and the like.

The control ASIC 61 has control circuits (namely, a CR motor driver 68, a PF motor driver 69 and a head driver 67) for controlling the rotation of the CR motor 70 and the PF motor 71, which are direct-current (DC) motors, and for controlling the driving of the recording head 42. The control ASIC 61 performs various calculation processes for controlling the rotation of the individual motors on the basis of a control command received from the CPU 65, an output signal from the PF rotary encoder 73, and an output signal from the CR linear encoder 72, and sends motor control signals obtained on the basis of the calculation results to the CR motor driver 68 and the PF motor driver 69.

Moreover, based on recording data received from the CPU 65, the control ASIC 61 calculates and generates a control signal for the recording head 42 and sends it to the head driver 67 so as to control the driving of the recording head 42. The control ASIC 61 also has a first sensor controller 81 and a second sensor controller 82. These sensor controllers perform switching control between a power supply mode and a power shutoff mode for the individual sensors.

The first sensor controller 81 controls the supply of power to the CR linear encoder 72, the PF rotary encoder 73, and the cover open/close sensor 77. On the other hand, the second sensor controller 82 controls the supply of power to the sheet detecting sensor 74, the PW sensor 75, and the tray storage sensor 76. The cover open/close sensor 77 is configured to detect an open/closed state of a cover (not shown) that covers a document table (not shown) included in the image reading unit 80.

A process for switching to a power-saving mode will now be described with reference to FIG. 4. The printer 1 is switched to a power-saving mode when all of the following conditions are satisfied: the recording head 42 is covered with the capping device 48 (YES in step S101), there are no sheets in the sheet transporting path (YES in step S102), no data is received for a predetermined time or more (YES in step S103), there are no button operations for a predetermined time or more (YES in step S104), and the cover of the image reading unit 80 is closed (YES in step S105).

In step S106, the present state of the printer 1 is stored, and in step S107, the printer 1 is switched to the power-saving mode. In the power-saving mode, the supply of power to the group of sensors (i.e., the sheet detecting sensor 74, the PW sensor 75, and the tray storage sensor 76) controlled by the corresponding drive sections and the second sensor controller 82 is discontinued, whereas the supply of power to the group of sensors (i.e., the CR linear encoder 72, the PF rotary encoder 73, and the cover open/close sensor 77) controlled by the first sensor controller 81 is continued.

A process for cancelling the power-saving mode will now be described with reference to FIG. 5. The power-saving mode is cancelled when any of the following conditions is satisfied: a change in state is detected by the cover open/close sensor 77 (YES in step S201), a change in state is detected by the PF rotary encoder 73 (YES in step S202), or a change in state is detected by the CR linear encoder 72 (YES in step S203).

When a change in state is detected by the PF rotary encoder 73 or the CR linear encoder 72, the amount of change is stored in step S204. In step S205, the previously-discontinued power supply to the group of sensors controlled by the corresponding drive sections and the second sensor controller 82 resumes. In step S206, an operation for recovering an ink system (I/S) after the power-saving mode is performed. In step S207, the carriage 40 is returned to the home position. The operation for recovering the ink system (I/S) after the power-saving mode includes performing maintenance on the recording head 42 (such as flushing ink from inkjet nozzles by idle-discharging or removing ink from the inkjet nozzles by suction).

In step S208, it is determined whether or not the disc tray 10 is set at the storage position. If the disc tray 10 is not set at the storage position, the process proceeds to step S209 where the disc tray 10 is transported towards the setting position. In step S210, the display portion of the operation panel 78 displays content (user action to be executed) previously displayed thereon prior to the transition to the power-saving mode.

As described above, in the power-saving mode, the control device 7 allows the supply of power to the CR linear encoder 72, which can detect movement of the carriage 40 acting as a drive section, to continue and also monitors an amount of movement of the carriage 40 so that, after the power-saving mode is cancelled, the present position of the carriage 40 can be ascertained without having to seek the home position of the carriage 40. Thus, when a recording execution command is received during the power-saving mode, recording can be commenced immediately.

Furthermore, in the power-saving mode, the control device 7 allows the supply of power to the PF rotary encoder 73, which can detect movement of the transport-driving roller 35 acting as a drive section, to continue and also monitors an amount of movement of the transport-driving roller 35. Thus, the power-saving mode is cancelled when a change in state is detected by the PF rotary encoder 73. Consequently, when the user performs an operation to move the disc tray 10, the power-saving mode is cancelled, whereby recording to be performed using the disc tray 10 can be commenced immediately. Furthermore, the control device 7 performs maintenance on the recording head 42 in step S206 after cancelling the power-saving mode. Therefore, even if an impact applied to the printer 1 during the power-saving mode causes air bubbles to form within the inkjet nozzles, such a state can be resolved so that a satisfactory recording result can be obtained.

What is claimed is:

1. A recording apparatus that performs recording on a recording medium, comprising:
a control unit that supplies power to a movement detecting unit, which is configured to detect movement of at least one drive section to be controlled, and monitors an amount of movement of the at least one drive section during a power-saving mode.

2. The recording apparatus according to claim 1, wherein the control unit cancels the power-saving mode when the movement detecting unit detects movement of the at least one drive section during the power-saving mode.

3. The recording apparatus according to claim 2, wherein the control unit performs maintenance on a recording head, which is configured to perform recording on the recording medium, after cancelling the power-saving mode.

4. The recording apparatus according to claim 1, further comprising:
a transport roller that acts as the at least one drive section and is configured to transport the recording medium;
a rotation detecting unit that acts as the movement detecting unit and is configured to detect rotation of the transport roller;
a tray that is provided in a shiftable manner between a setting position, a recording position, and a storage position, the tray being shifted to the setting position by being ejected from an interior to an exterior of the apparatus so that a thin-plate body is settable on the tray, the recording position being where recording is performed on the thin-plate body, the storage position being where the tray is stored inside the apparatus; and
a tray driving unit that is configured to shift the tray by receiving power from a motor via the transport roller,
wherein the control unit cancels the power-saving mode when the rotation detecting unit detects rotation of the transport roller during the power-saving mode.

5. An electronic apparatus comprising:
at least one drive section;
a movement detecting unit that is configured to detect movement of the at least one drive section; and
a control unit that controls the movement of the at least one drive section on the basis of information sent from the movement detecting unit and controls supply of power to the at least one drive section and the movement detecting unit,
wherein the control unit supplies power to the movement detecting unit and monitors an amount of movement of the at least one drive section during a power-saving mode.
